(19) United States
(12) Patent Application Publication
(10) Pub. No.: US 2023/0214629 A1
(43) Pub. Date: Jul. 6, 2023

(54) TRANSFORMER-BASED AUTOREGRESSIVE LANGUAGE MODEL SELECTION

(71) Applicant: Microsoft Technology Licensing, LLC, Redmond, WA (US)

(72) Inventors: Debadeepta Dey, Kenmore, WA (US); Shital Rajnikant Shah, Sammamish, WA (US); Gustavo Henrique De Rosa, Curitiba (BR); Caio César Teodoro Mendes, Espirito Santo do Pinhal (BR); Sebastien Bubeck, Seattle, WA (US); Tomasz Lukasz Religa, Seattle, WA (US); Saurabh Vasant Naik, Redmond, WA (US); Yan He, Issaquah, WA (US); Subhabrata Mukherjee, Kirkland, WA (US); Mojan Javaheripi, San Diego, CA (US)

(21) Appl. No.: 17/566,375

(22) Filed: Dec. 30, 2021

(51) Int. Cl. G06N 3/04; G06F 40/274; G06K 9/62

(52) U.S. Cl. CPC G06N 3/04; G06F 40/274; G06K 9/6262

(57) ABSTRACT

Generally discussed herein are devices, systems, and methods for improving architecture search and identification with constraints. A method can include receiving, at a compute device, a request for a transformer-based autoregressive language model (TBALM), the request specifying a maximum latency, identifying TBALM architectures that satisfies the maximum latency, identifying a TBALM architecture of the identified TBALM architectures that has a greatest number of decoder parameters resulting in an identified TBALM architecture, and providing the identified TBALM architecture.

### BACKGROUND

For the task of text prediction on a client device, it is beneficial for a chosen neural network (NN) architecture to meet performance criteria like latency, peak memory consumed, and perplexity. Manually searching for such architectures is tedious and time-consuming as it involves manually searching through an exploding number of combinatorial choices (often in the range of 10²⁰ or greater NN architectures). Moreover, this search is device-specific, and a search completed for one device does not necessarily indicate the selected architecture is suitable for implementation on another device. The search should be repeated for each client device (e.g., laptop with Intel Core-i3, Intel Core-i5, iPhone 13, Pixel 5, etc) since each device has processors with differing capabilities, memory constraints, and data pipelines. Such searching using current search techniques consumes a prohibitively large amount of time and compute resources, such that most people consider these techniques practically intractable.

### SUMMARY

A device, system, method, and computer-readable medium configured for improved transformer-based autoregressive language model (TBALM) identification. TBALM identification can use a number of decoder parameters as a proxy for architecture accuracy, thus alleviating a need to train and execute the model to determine an accuracy of the model. Using the number of decoder parameters as a proxy for accuracy allows architecture search to be performed on a client device, such as a smartphone, tablet, laptop, internet of things (IoT) device, or the like, or a compute device with more processor or memory bandwidth.

A method can include receiving, at a compute device, a request for a transformer-based autoregressive language model (TBALM). The request can specify a maximum latency. The method can further include identifying TBALM architectures that satisfy the maximum latency (include a latency less than the maximum specified latency). The method can include identifying a TBALM architecture of the identified TBALM architectures that has a greatest number of decoder parameters resulting in an identified TBALM architecture. The method can include providing the identified TBALM architecture.

The method can include, wherein the request further specifies a maximum amount of memory consumed by the TBALM. The method can include identifying the TBALM architecture includes identifying the TBALM architecture of the respective architectures that (i) satisfies the maximum latency, (ii) satisfies the maximum amount of memory consumed, and (iii) has a greatest number of decoder parameters for the architectures that satisfy both the maximum latency and maximum amount of memory consumed resulting in the identified TBALM architecture.

The method can include using a total number of decoder parameters of the architecture as a proxy for architecture accuracy. The method can include, wherein the total number of decoder parameters includes weights and biases of only the decoder of the TBALM architecture. The method can include, wherein the decoder parameters include, of the identified TBALM architecture weights of attention heads, model dimensions, inner dimension of a feed forward network (FFN), and number of decoder layers.

The method can include, wherein the compute device is a client device. The method can further include generating, by the compute device, a pareto curve of number of decoder parameters versus latency for a variety of TBALM architectures, based on a processor of the compute device resulting in a generated pareto curve. The method can further include, wherein identifying the TBALM architecture of the respective architectures that (i) satisfies the maximum latency and (ii) has a greatest number of decoder parameters for the architectures that satisfy the maximum latency includes selecting the TBALM corresponding to a point at a boundary of the generated pareto curve. A device or computer-readable medium can be configured to perform the operations of the method.

### BRIEF DESCRIPTION OF DRAWINGS

FIG. 1 illustrates, by way of example, a block diagram of an embodiment of a TBALM.

FIG. 2 illustrates, by way of example, a graph of perplexity versus total number of parameters for the TBALM.

FIG. 3 illustrates, by way of example, a graph of percentage of parameters consumed by decoding layers versus type of decoding layers.

FIG. 4 illustrates, by way of example, a graph of Spearman's correlation versus top k (as a percentage).

FIG. 5 illustrates, by way of example, a graph of Spearman's correlation versus top k (as a percentage).

FIG. 6 illustrates, by way of example, a graph of latency versus number of decoder parameters of a variety of TBALM architectures.

FIG. 7 illustrates, by way of example, a flow diagram of an embodiment of a method for architecture search and identification.

FIG. 8 illustrates, by way of example a diagram of an embodiment of use cases for the method of FIG. 7 or other embodiments provided herein.

FIG. 9 is a block diagram of an example of an environment including a system for neural network training, use of which is avoided in performing TBALM architecture search in accord with embodiments.

FIG. 10 illustrates, by way of example, a block diagram of an embodiment of a machine (e.g., a computer system) to implement one or more embodiments.

### DETAILED DESCRIPTION

Embodiments provide a way to automatically determine an optimal or near-optimal neural network (NN) architecture for a transformed based autoregressive language model (TBALM). TBALMs have similar performance (in terms of perplexity) independent of architecture shape (e.g., number of layers, dimension of embedding, dimension of feedforward (FF) NN in the transformer block, or the like) and are mainly dependent on total number of non-embedding parameters in the architecture. Non-embedding parameters are parameters of the decoder. This insight that TBALM performance is mainly dependent on a total number of decoder parameters in the architecture enables an on-device multi-objective neural architecture search where any candidate architecture does not need to be trained at all and its performance relative to other architectures can be ascertained by measuring the differences in decoder parameter counts. Evaluating candidate architectures via a decoder parameter count proxy makes it feasible to run the architecture search directly on even low-end devices. On low-end devices, the search often takes only a few minutes using an architecture search algorithm (e.g., any suitable search algorithm).

Current NN architecture search algorithms are very computationally expensive due to the cost of training a potentially large number of promising candidate architectures. But using the insight that, for the specific task of TBALM architecture search, one need not actually train any candidate architecture at all but get a cheap proxy for its performance using non-embedding parameter counts only, one can run a search on even low-end devices directly in a few minutes as opposed to thousands of graphics processing unit (GPU) operation hours.

Searching based on number of non-embedding parameters enables optimal or near-optimal architectures to be quickly found for every potential client device. The power of searching in this manner has been reviewed by performing the search on a low-end Azure virtual machine (VM) stock keeping unit (SKU), low-end central processing unit (CPU), as well as powerful server-grade VMs with expensive GPUs. Architectures found via the search technique have better performance criteria as compared to naively scaling architectures up or down via changing the number of layers which is often the canonical handcrafted technique.

A traditional technique for determining which NN architecture to employ can include a user having a problem that can be solved using an NN, such as image classification, text prediction, or the like. However, there are a very large number, potentially infinite, of possible NN architectures and the user is unsure how to design the NN to efficiently and accurately solve the problem encountered by the user. The user can be unsure how many NN layers to use, what should be inside each layer, the form an output layer should take, the form an embedding layer should take, or the like.

The same user or another user can then perform a trial-and-error approach to designing the NN architecture sufficient to solve the problem. The user can select a design, train the selected NN architecture, and test the NN architecture. If the NN architecture satisfies specified criterion of the user the NN architecture can be used. While the NN architecture solves the criterion, the user is unsure whether they have the best architecture for what they want to accomplish, given resource constraints of a device on which the architecture is to be implemented (e.g., processing bandwidth, peak memory usage, or the like), an acceptable latency of operation, or the like. In the context of text prediction 20 to 30 milliseconds is a generally acceptable upper limit for latency that does not degrade user experience. Memory and processing bandwidth are different for different devices.

Such constraints can be visualized or modelled as a multidimensional cost surface or surface utility. It is very difficult, if not impossible, for a person to determine the optimal operating conditions by hand. One way people have tried to solve this issue is by generating a trade-off curve (sometimes called a Pareto curve) and selecting an architecture based on the curve. Generating the trade-off curve is traditionally very labor intensive and operates in this manner. The user selects a model, trains it, plots its performance on the trade-off curve, and repeats until the user is satisfied that enough points have been plotted to get an accurate depiction of the trade-off.

Considering that each model choice, even on the most state-of-the-art equipment and using the most state-of-the-art techniques for training, requires a lot of time for training (e.g., one GPU day or more) and there are usually many architecture choices (10²⁰ or more) generating the trade-off curve in this manner is generally not feasible.

Embodiments provide an ability to efficiently generate the trade-off-curve for a subset of models, such as TBALM. Embodiments provide the trade-off curve and a corresponding architecture without classic efficiency-increasing techniques, such as pruning, distillation, or quantization. In pruning, a user starts with a larger architecture and removes a portion of the architecture, such as one or more layers, connections between neurons, or the like, resulting in a smaller architecture. The smaller architecture is typically similar in accuracy to the larger architecture. Distillation is a process for model compression, in which a smaller (“student”) model is trained in an attempt to match the classification capability of a larger pre-trained (“teacher”) model. Knowledge is transferred from the teacher model to the student by minimizing a loss function, aimed at matching softened teacher logits as well as ground-truth labels. Quantization is the reduction of the size of memory consumed by parameters. For example, a 64-bit quantity can be mapped to a 32-bit, yielding memory savings. With an accurate larger model, it is still unknown whether that accurate larger model is an optimal choice for pruning, distillation, quantization, or a combination thereof.

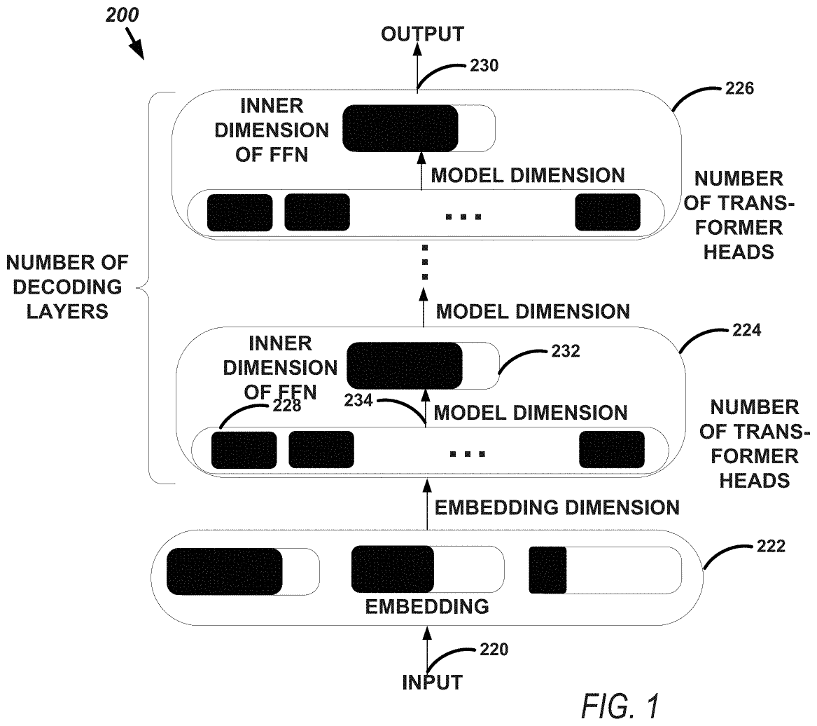

FIG. 1 illustrates, by way of example, a block diagram of an embodiment of a TBALM 200. The TBALM 200 receives an input 220 that is typically in the form of a tokenized-text representation. The input 220 is projected to an embedding space by one or more embedding layers 222 resulting in embedded tokens. The embedded tokens are then provided to decoding layers 224, 226 of the TBALM 200. The decoding layers 224, 226 provide a vector indicating a likelihood of text being a valid prediction of what a user is intending by the input 220.

Tokenization is a common task in NLP. Tokenization converts provided text into the building blocks of natural language. Tokens can be words, characters, or subwords. Word2Vec and GloVe are examples of word-level tokenizers. N-gram tokenization and byte pair encoding (BPE) are examples of subword tokenizers.

In terms of parameters, the embedding layer 222 typically includes more than half of the total parameters of a given model, depending on how the vocabulary space is defined. One way to help optimize the parameters stored to represent the embedding space can include clustering words based on term frequency-inverse document frequency (tf-idf) or other frequency metric. Then, the most commonly used words can be represented by a lower-dimensional vector in the embedding space, while the less commonly used words can be represented by a higher-dimensional vector in embedding space. Note that parameters, in the context of the embedding layer 222 and the decoding layers 224, 226, are the actual parameters of the layer as opposed to hyperparameters of the TBALM 200. Hyperparameters are parameters that are not learned during training and are defined to guide the training of the model. Parameters can be learned during training, such as the parameters of the decoding layers 224, 226. Parameters can be defined or determined in advance of training, such as the parameters of the embedding layer 222.

The embedded tokens are input to a sequence of transformer layers, the decoding layers 224, 226. The decoding layers 224, 226 include a number of attention heads 228 followed by a feed forward network (FFN) 232. The number of attention heads 228 is typically a power of two (2) so that an accelerator can make the operation faster. The attention heads 228 can provide an output of a specified model dimension 234. The FFN 232 has an inner dimension that indicates the number of parameters consumed in projecting the output of the attention heads 228 to higher dimensional space and back down to model dimension 234 space. The model dimension 234 and inner dimension of the FFN 232 are variable in size, and so are the number of decoding layers 224, 226 and the number of transformer heads 228. This variability in the model dimension 234, inner dimension of the FFN 232, the number of decoding layers 224, 226 and the number of attention heads 228 makes it very difficult, if not impossible, to determine whether an architecture of a TBALM 200 is optimal given one or more constraints. If each of the decoder layers 224, 226 are homogeneous, then the variability is reduced, but there are still a large number of architectures to explore to identify the optimal architecture. If the decoder layers 224, 226 are heterogeneous, this makes the number of potential architectures to test even greater, thus making the determination of the optimal architecture even more difficult. It would be advantageous to generate the trade-off curve quickly and associate a given architecture with a given point on the trade-off curve. A user could select a point on the curve that corresponds to their desired operation accuracy, maximum memory consumed, processor bandwidth consumed, or a combination thereof. That point can be converted to an architecture that operates to satisfy the constraints of the user.

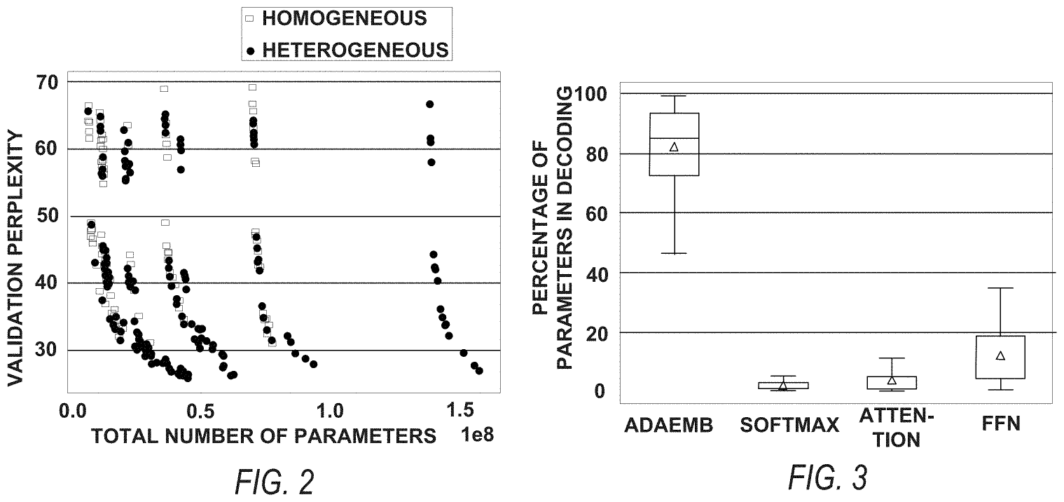

FIG. 2 illustrates, by way of example, a graph of perplexity versus total number of parameters for the TBALM. Note that, at each number of parameters, there is a wide range of perplexity. The squares in the graphs are for homogeneous architectures, while circles in the graphs are for heterogeneous architectures. Perplexity is a measurement of how well a distribution predicts a sample. A low perplexity indicates the probability distribution is good at predicting the sample. Perplexity is a function of entropy. The different “L” shaped patterns are from using different embedding layers 222. Since the number of parameters in embedding layers is in a wide range (e.g., [50000, 700000] or a greater or lesser number of parameters). The embedding layers can account for a large portion of the parameters of the architecture.

FIG. 3 illustrates, by way of example, a graph of percentage of parameters consumed by all decoding layers 224, 226 versus type of decoding layers. FIG. 3 was generated based on homogeneous architectures. The triangle in FIG. 3 indicates average. The lines on each side of the box for a given decoder type indicate 25^{th} and 75^{th} percentile. As can be seen, for most types of decoding layers, the decoding layers 224, 226 consume less than 20% of all the parameters of the model. The remainder of the parameters, typically a majority, are consumed by the embedding layer 222.

It would be beneficial to rank architectures without having to instantiate or train the architectures. This allows the designer to save an enormous amount of time while not sacrificing accuracy. One possible way would be to count the total number of parameters of a given architecture and rank the architectures based on the total number of parameters.

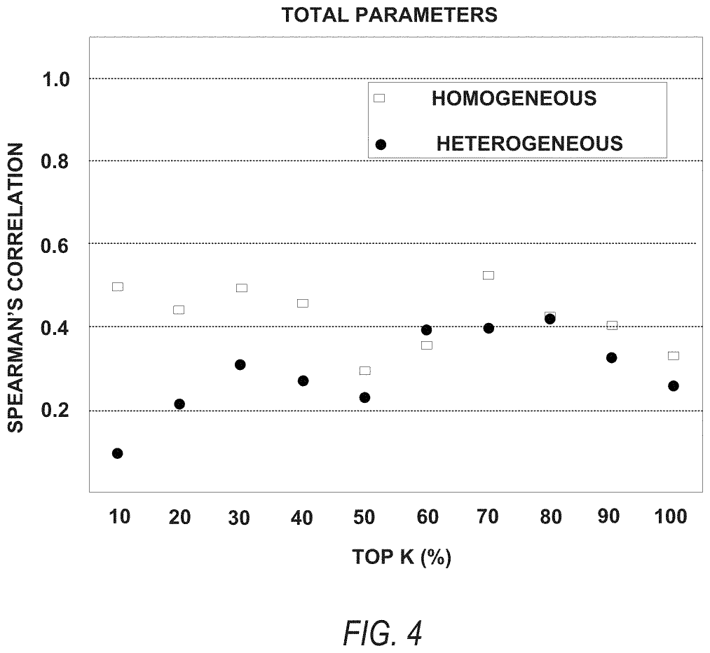

FIG. 4 illustrates, by way of example, a graph of Spearman's correlation versus top k ranking (as a percentage). Spearman's correlation is a rank correlation. Spearman's correlation is a nonparametric measure of rank correlation (statistical dependence between the rankings of two variables). Spearman's correlation assesses how well the relationship between two variables can be described using a monotonic function. The Spearman correlation between two variables will be high when observations have a similar (or identical for a correlation of 1) rank (e.g., relative position label of the observations within the variable: 1st, 2nd, 3rd, etc.) between the two variables, and low when observations have a dissimilar (or fully opposed for a correlation of −1) rank between the two variables.

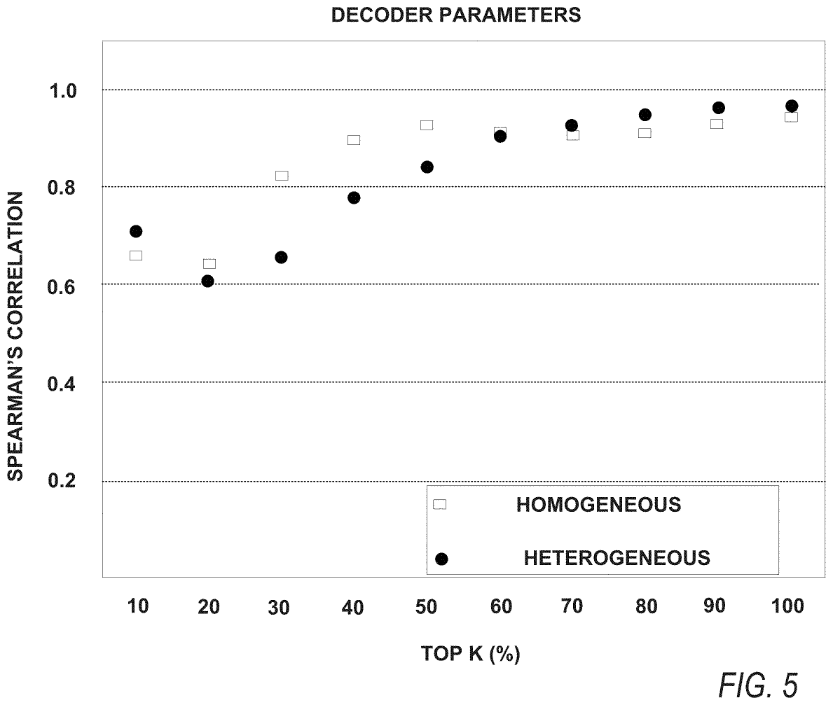

As can be seen, the correlation between the top k ranking and the total number of parameters of the network is low. The top k ranking is a ground truth ranking in terms of accuracy. This indicates that the total number of parameters is not a good proxy for the accuracy of the architecture. In generating the graph of FIG. 5, hundreds of architectures at a variety of total number of parameters were instantiated, trained, and tested.

Note that the plot of FIG. 4 considers all parameters of the architecture and indicates that a sum total of the parameters in the architecture is not a good proxy for perplexity of the architecture. Consider that, in some embodiments, only that decoder parameters are used during inference time, such as when the embedding space is encoded as a lookup table (LUT). Decoder parameters are those used in the decoding layers, such as the number of attention heads 228, the dimension of the output of the attention heads (model dimension), and inner dimension of the FFN 232. The number of decoding layers can be relevant for homogeneous architectures. One possible way to rank the architectures can be based on only the number of decoder parameters.

FIG. 5 illustrates, by way of example, a graph of Spearman's correlation versus top k (as a percentage). As can be seen, the correlation between the top k ranking the number of parameters in the decoding layers are strongly correlated. This indicates that the total number of parameters of the decoding layers of the TBALM are a good proxy for the accuracy of the architecture. In generating the graph of FIG. 5, hundreds of architectures at a variety of total number of parameters were instantiated, trained, and tested.

This insight allows the accuracy of a TBALM model to be predicted based on the number of parameters in the decoding layer(s). One can simply count the number of parameters in the decoder layers and use that as a proxy for architecture accuracy. This allows a user to fix the memory constraints, processing constraints, perplexity, latency, or other architecture constraints, and search the space of TBALM architectures for the most accurate architecture based on only the number of parameters in the decoding layers. Even low processor power and lower memory available devices can perform a search of architecture space to find an architecture that fits their constraints and is sufficiently, sometimes even optimally, accurate.

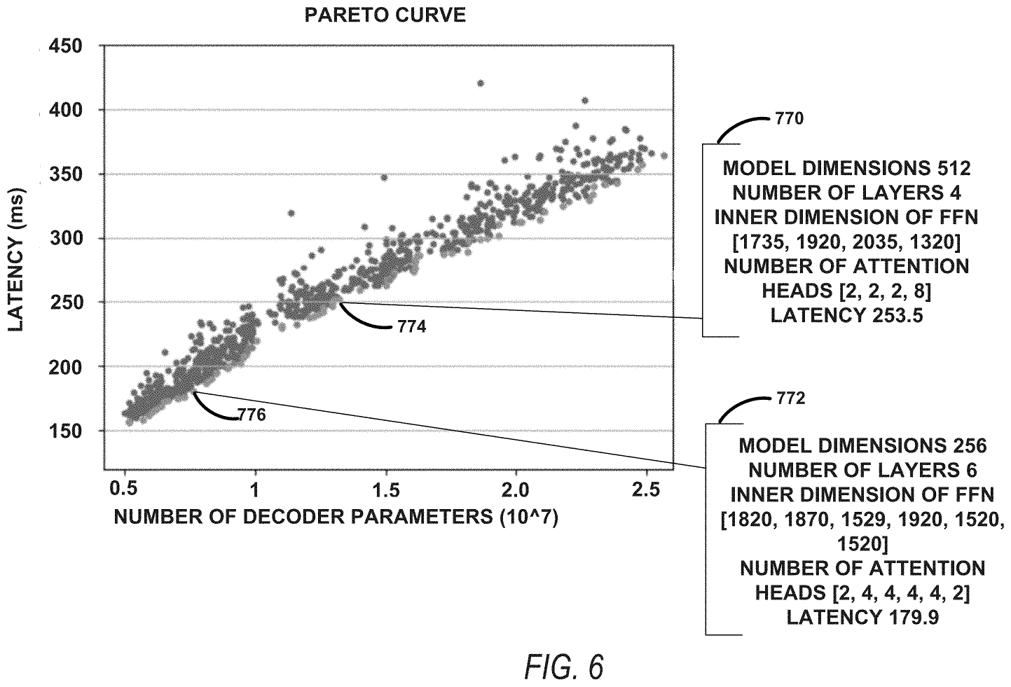

FIG. 6 illustrates, by way of example, a graph of latency versus number of decoder parameters of a variety of TBALM architectures. Each of the points of the graph is associated with an architecture that defines the shape (e.g., number of attention heads, model dimension, inner dimension of FFN, number of layers, or the like) of the architecture. The number of parameters can be determined based on the shape of the architecture. The latency (and other attributes like memory consumption) can be determined on-device directly by passing an example input through the network and measuring the respective values. With the insight that the number of decoder parameters correlates with accuracy of the model, a user can select a point at the latency they are willing to tolerate. The architecture associated with that point indicates to the user an architecture that satisfies those latency constraints. If the user wants a model with a near-optimal accuracy, they can select the point lowest on the graph that corresponds to the most number of decoder parameters for that latency. That architecture corresponds to the most decoder parameters for the given latency. Since the number of decoder parameters is correlated with accuracy (with higher number of decoder parameters more likely to correspond to a more accurate model), that architecture is likely to be optimal or near-optimal accuracy for the given latency.

Two example architectures 770, 772 for given points 774, 776, respectively, are provided in FIG. 6. The point 774 corresponds to a latency of about 250 ms and has about 14,000,000 decoder parameters. The point 776 has a latency of about 175 ms and about 8,000,000 decoder parameters.

The parameters of the decoding layers are counted per entry of weight vector, bias vector, or the like. The parameters of the decoding layers are distinct from hyperparameters which are not learned during training. The biases and weights are learned during training. Consider the architecture 770. Counting the number of decoder parameters can be performed as follows:

The parameters of the decoding layers are counted per entry of weight vector, bias vector, or the like. The parameters of the decoding layers are learned during training and are distinct from hyperparameters which are not learned during training. Counting the number of decoder parameters can be performed using the following formulas:

Number or parameters in a feed forward network=2*model_dimensions*inner_dimensions+inner_dimension+3*model_dimensions

Number of parameters in an attention head=5*model_dimensions*head_dimensions*number_of_heads+2*model_dimenions

So, for the architecture 770, the number of decoder layer dimensions is as follows:

Decoder Layer 1:

Feed forward network: 2*512*1735+1735+3*512=1,779,911

Attention head: 5*512*512*2+2*512=2,622,464

Decoder Layer 2:

FF: 2*512*1920+1920+3*512=1,969,536

Attn: 5*512*512*2+2*512=2,622,464

Decoder Layer 3:

FF: 2*512*2035+2035+3*512=2,087,411

Attn: 5*512*512*2+2*512=2,622,464

Decoder Layer 4:

FF: 2*512*1320+1320+3*512=1,354,536

Attn: 5*512*512*8+8*512=10,489,856

Summing up all these values=25,548,642 decoder parameters in the architecture 770. Then, a similar calculation can be performed on the architecture 772. The number of decoder parameters of the two architectures 770, 772 can be compared, and the architecture with the greater number of decoder parameters can be assumed to be more accurate.

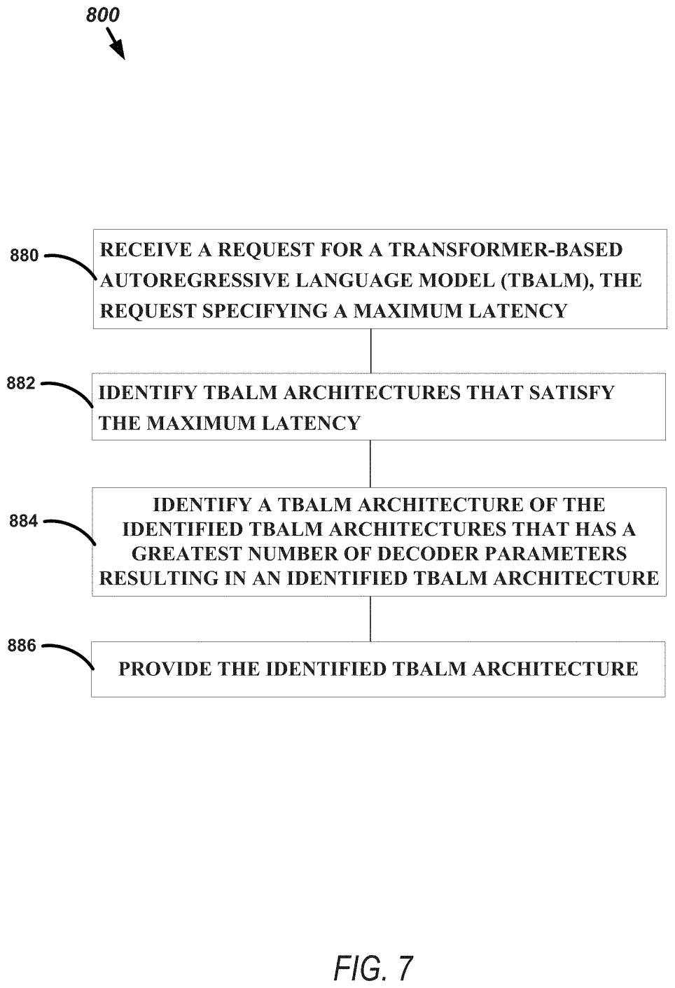

FIG. 7 illustrates, by way of example, a flow diagram of an embodiment of a method 800 for architecture search and identification. The method 800 as illustrated includes receiving (e.g., at a compute device) a request for a transformer-based autoregressive language model (TBALM), the request specifying a maximum latency, at operation 880; identifying TBALM architectures that satisfy the maximum latency, at operation 882; identifying a TBALM architecture of the identified TBALM architectures that has a greatest number of decoder parameters resulting in an identified TBALM architecture, at operation 884; and providing the identified TBALM architecture, at operation 886.

The method 800 can further include, wherein the request further specifies a maximum amount of memory consumed by the TBALM. The method 800 can further include identifying the TBALM architecture includes identifying the TBALM architecture of the respective architectures that (i) satisfies the maximum latency, (ii) satisfies the maximum amount of memory consumed, and (iii) has a greatest number of decoder parameters for the architectures that satisfy both the maximum latency and maximum amount of memory consumed resulting in the identified TBALM architecture.

The method 800 can further include using a total number of decoder parameters of the architecture as a proxy for architecture accuracy. The method 800 can further include, wherein the total number of decoder parameters includes weights and biases of only the decoder of the TBALM architecture. The method 800 can further include, wherein the decoder parameters include, of the identified TBALM architecture weights of attention heads, model dimensions, inner dimension of a feed forward network (FFN), and number of decoder layers. The method 800 can further include, wherein the compute device is a client device. The method 800 can further include generating, by the compute device, a pareto curve of number of decoder parameters versus latency for a variety of TBALM architectures, based on a processor of the compute device resulting in a generated pareto curve. The method 800 can further include, wherein identifying the TBALM architecture of the respective architectures that (i) satisfies the maximum latency and (ii) has a greatest number of decoder parameters for the architectures that satisfy the maximum latency includes selecting the TBALM corresponding to a point at a boundary of the generated pareto curve.

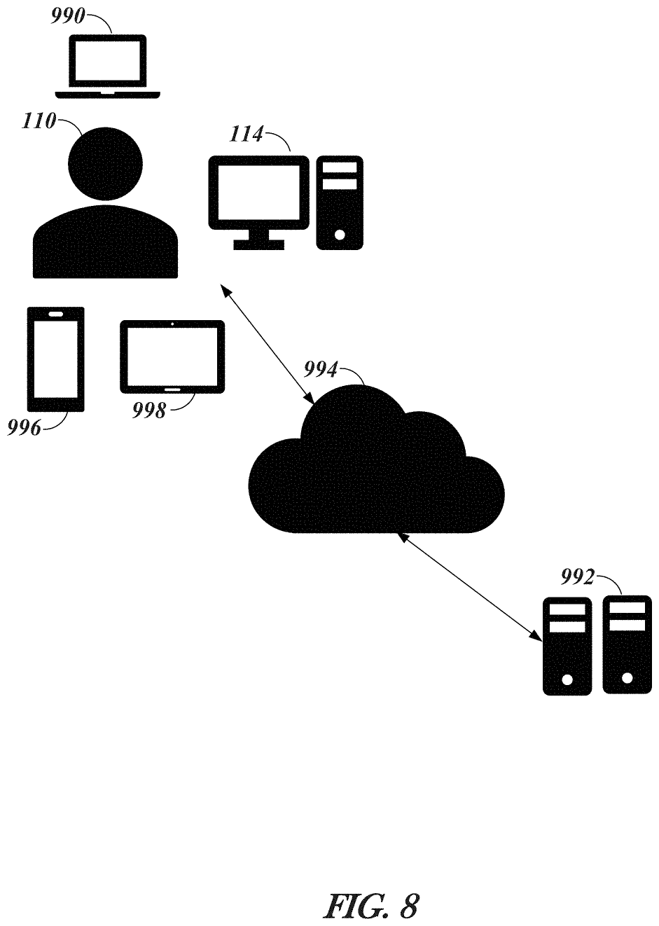

FIG. 8 illustrates, by way of example a diagram of an embodiment of use cases for the method 800 or other embodiments provided herein. FIG. 8 includes the user 110 with a need or desire to generate a TBALM model that operates on a client device 990, 114, 996, 998. The client device 990 is a laptop computer, the client device 114 is a desktop computer, the client device 996 is a smartphone, and the client device 998 is table computer. The user 110 has constraints for the TBALM model, such as maximum memory consumed by the model or latency for the model providing a text prediction. The maximum memory consumed can be different for different client devices 990, 114, 996, 998 as the memory onboard these devices is likely of different size. The latency of a given model can be different for different client devices 990, 114, 996, 998 as the compute architectures of the client devices 990, 114, 996, 998 are likely different. Thus, a latency for one client device 990, 114, 996, 998 will very likely not be valid for another of the client devices 990, 114, 996, 998. Thus, one model may operate to satisfy the constraints for one client device 990, 114, 996, 998 but may not operate to satisfy the constraints for another of the client devices 990, 114, 996, 998.

The user 110 can connect to a remote service, provided by servers 992 and accessed through cloud 994, or can execute the method 800 locally on the user device 990, 114, 996, 998. The user 110 can provide a request that specifies constraints to be satisfied by a TBALM architecture. One or more of the constraints can be defined expressly, such as by the user 110 indicating the latency, maximum memory consumed, or the like. One or more of the constraints can be defined implicitly, such as by the user 110 indicating the client device 990, 114, 996, 998 on which the TBALM architecture is to be executed. The client device 990, 114, 996, 998 can have known parameters that allow the maximum memory consumption allowed by the client device 990, 114, 996, 998 to be determined without the user 110 specifying the same. The method 800 can provide data to the user 110 (by the device 990, 114, 996, 998) that indicates a TBALM architecture that satisfies constraints specified by the user 110 or can provide the TBALM architecture, a trained version of the TBALM architecture, or the like, responsive to the request.

Artificial intelligence (AI) is a field concerned with developing decision-making systems to perform cognitive tasks that have traditionally required a living actor, such as a person. NNs are computational structures that are loosely modeled on biological neurons. Generally, NNs encode information (e.g., data or decision making) via weighted connections (e.g., synapses) between nodes (e.g., neurons). Modern NNs are foundational to many AI applications, such as text prediction.

Many NNs are represented as matrices of weights (sometimes called parameters) that correspond to the modeled connections. NNs operate by accepting data into a set of input neurons that often have many outgoing connections to other neurons. At each traversal between neurons, the corresponding weight modifies the input and is tested against a threshold at the destination neuron. If the weighted value exceeds the threshold, the value is again weighted, or transformed through a nonlinear function, and transmitted to another neuron further down the NN graph—if the threshold is not exceeded then, generally, the value is not transmitted to a down-graph neuron and the synaptic connection remains inactive. The process of weighting and testing continues until an output neuron is reached; the pattern and values of the output neurons constituting the result of the NN processing.

The optimal operation of most NNs relies on accurate weights. However, NN designers do not generally know which weights will work for a given application. NN designers typically choose a number of neuron layers or specific connections between layers including circular connections. A training process, which is not required by embodiments thus saving search time, may be used to determine appropriate weights by selecting initial weights. The following description of training provides an explanation of the work that is avoided by embodiments but was required in prior solutions to the same problem of TBALM architecture search.

In some examples, initial weights may be randomly selected. Training data is fed into the NN and results are compared to an objective function that provides an indication of error. The error indication is a measure of how wrong the NN's result is compared to an expected result. This error is then used to correct the weights. Over many iterations, the weights will collectively converge to encode the operational data into the NN. This process may be called an optimization of the objective function (e.g., a cost or loss function), whereby the cost or loss is minimized.

A gradient descent technique is often used to perform the objective function optimization. A gradient (e.g., partial derivative) is computed with respect to layer parameters (e.g., aspects of the weight) to provide a direction, and possibly a degree, of correction, but does not result in a single correction to set the weight to a “correct” value. That is, via several iterations, the weight will move towards the “correct,” or operationally useful, value. In some implementations, the amount, or step size, of movement is fixed (e.g., the same from iteration to iteration). Small step sizes tend to take a long time to converge, whereas large step sizes may oscillate around the correct value or exhibit other undesirable behavior. Variable step sizes may be attempted to provide faster convergence without the downsides of large step sizes.

Backpropagation is a technique whereby training data is fed forward through the NN—here “forward” means that the data starts at the input neurons and follows the directed graph of neuron connections until the output neurons are reached—and the objective function is applied backwards through the NN to correct the synapse weights. At each step in the backpropagation process, the result of the previous step is used to correct a weight. Thus, the result of the output neuron correction is applied to a neuron that connects to the output neuron, and so forth until the input neurons are reached. Backpropagation has become a popular technique to train a variety of NNs. Any well-known optimization algorithm for back propagation may be used, such as stochastic gradient descent (SGD), Adam, etc.

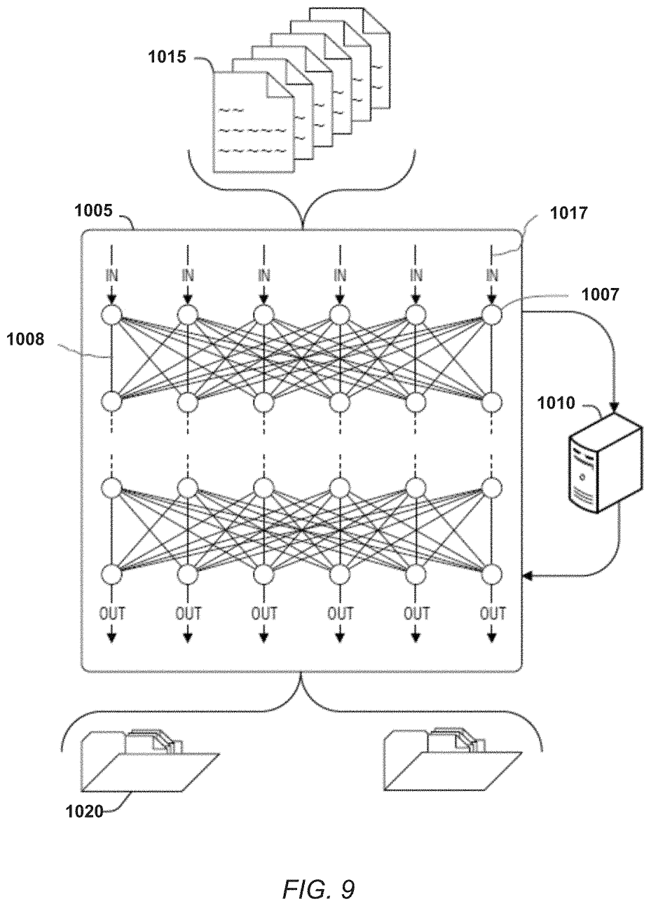

FIG. 9 is a block diagram of an example of an environment including a system for neural network training. The system can predict text that is to be entered based on text that has been entered. The system includes an artificial NN (ANN) 1005 that is trained using a processing node 1010. The processing node 1010 may be a central processing unit (CPU), graphics processing unit (GPU), field programmable gate array (FPGA), digital signal processor (DSP), application specific integrated circuit (ASIC), or other processing circuitry. In an example, multiple processing nodes may be employed to train different layers of the ANN 1005, or even different nodes 1007 within layers. Thus, a set of processing nodes 1010 is arranged to perform the training of the ANN 1005.

The set of processing nodes 1010 is arranged to receive a training set 1015 for the ANN 1005. The ANN 1005 comprises a set of nodes 1007 arranged in layers (illustrated as rows of nodes 1007) and a set of inter-node weights 1008 (e.g., parameters) between nodes in the set of nodes. In an example, the training set 1015 is a subset of a complete training set. Here, the subset may enable processing nodes with limited storage resources to participate in training the ANN 1005.

The training data may include multiple numerical values representative of a domain, such as a word, symbol, other part of speech, or the like. Each value of the training or input 1017 to be classified after ANN 1005 is trained, is provided to a corresponding node 1007 in the first layer or input layer of ANN 1005. The values propagate through the layers and are changed by the objective function.

As noted, the set of processing nodes is arranged to train the neural network to create a trained neural network. After the ANN is trained, data input into the ANN will produce valid classifications 1020 (e.g., the input data 1017 will be assigned into categories), for example. The training performed by the set of processing nodes 1007 is iterative. In an example, each iteration of the training the ANN 1005 is performed independently between layers of the ANN 1005. Thus, two distinct layers may be processed in parallel by different members of the set of processing nodes. In an example, different layers of the ANN 1005 are trained on different hardware. The members of different members of the set of processing nodes may be located in different packages, housings, computers, cloud-based resources, etc. In an example, each iteration of the training is performed independently between nodes in the set of nodes. This example is an additional parallelization whereby individual nodes 1007 (e.g., neurons) are trained independently. In an example, the nodes are trained on different hardware.

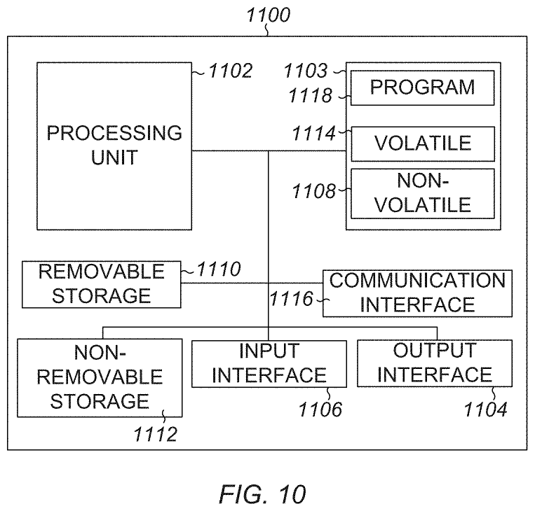

FIG. 10 illustrates, by way of example, a block diagram of an embodiment of a machine 1100 (e.g., a computer system) to implement one or more embodiments. The machine 1100 can implement a technique for improved contextual data provisioning in a conference. The client device 990, 114, 996, 998, server 992, or a component thereof can include one or more of the components of the machine 1100. One or more of the method 800, client device 990, 114, 996, 998, server 992, or a component or operations thereof can be implemented, at least in part, using a component of the machine 1100. One example machine 1100 (in the form of a computer), may include a processing unit 1102, memory 1103, removable storage 1110, and non-removable storage 1112. Although the example computing device is illustrated and described as machine 1100, the computing device may be in different forms in different embodiments. For example, the computing device may instead be a smartphone, a tablet, smartwatch, or other computing device including the same or similar elements as illustrated and described regarding FIG. 10. Devices such as smartphones, tablets, and smartwatches are generally collectively referred to as mobile devices. Further, although the various data storage elements are illustrated as part of the machine 1100, the storage may also or alternatively include cloud-based storage accessible via a network, such as the Internet.

Memory 1103 may include volatile memory 1114 and non-volatile memory 1108. The machine 1100 may include—or have access to a computing environment that includes—a variety of computer-readable media, such as volatile memory 1114 and non-volatile memory 1108, removable storage 1110 and non-removable storage 1112. Computer storage includes random access memory (RAM), read only memory (ROM), erasable programmable read-only memory (EPROM) & electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices capable of storing computer-readable instructions for execution to perform functions described herein.

The machine 1100 may include or have access to a computing environment that includes input 1106, output 1104, and a communication connection 1116. Output 1104 may include a display device, such as a touchscreen, that also may serve as an input device. The input 1106 may include one or more of a touchscreen, touchpad, mouse, keyboard, camera, one or more device-specific buttons, one or more sensors integrated within or coupled via wired or wireless data connections to the machine 1100, and other input devices. The computer may operate in a networked environment using a communication connection to connect to one or more remote computers, such as database servers, including cloud-based servers and storage. The remote computer may include a personal computer (PC), server, router, network PC, a peer device or other common network node, or the like. The communication connection may include a Local Area Network (LAN), a Wide Area Network (WAN), cellular, Institute of Electrical and Electronics Engineers (IEEE) 802.11 (Wi-Fi), Bluetooth, or other networks.

Computer-readable instructions stored on a computer-readable storage device are executable by the processing unit 1102 (sometimes called processing circuitry) of the machine 1100. A hard drive, CD-ROM, and RAM are some examples of articles including a non-transitory computer-readable medium such as a storage device. For example, a computer program 1118 may be used to cause processing unit 1102 to perform one or more methods or algorithms described herein.

The operations, functions, or algorithms described herein may be implemented in software in some embodiments. The software may include computer executable instructions stored on computer or other machine-readable media or storage device, such as one or more non-transitory memories (e.g., a non-transitory machine-readable medium) or other type of hardware-based storage devices, either local or networked. Further, such functions may correspond to subsystems, which may be software, hardware, firmware, or a combination thereof. Multiple functions may be performed in one or more subsystems as desired, and the embodiments described are merely examples. The software may be executed on a digital signal processor, ASIC, microprocessor, central processing unit (CPU), graphics processing unit (GPU), field programmable gate array (FPGA), or other type of processor operating on a computer system, such as a personal computer, server or other computer system, turning such computer system into a specifically programmed machine. The functions or algorithms may be implemented using processing circuitry, such as may include electric and/or electronic components (e.g., one or more transistors, resistors, capacitors, inductors, amplifiers, modulators, demodulators, antennas, radios, regulators, diodes, oscillators, multiplexers, logic gates, buffers, caches, memories, GPUs, CPUs, field programmable gate arrays (FPGAs), or the like).

### ADDITIONAL NOTES AND EXAMPLES

Example 1 can include a method comprising receiving, at a compute device, a request for a transformer-based autoregressive language model (TBALM), the request specifying a maximum latency, identifying TBALM architectures that satisfy the maximum latency, identifying a TBALM architecture of the identified TBALM architectures that has a greatest number of decoder parameters resulting in an identified TBALM architecture, and providing the identified TBALM architecture.

In Example 2, Example 1 can further include, wherein the request further specifies a maximum amount of memory consumed by the TBALM, and identifying the TBALM architecture includes identifying the TBALM architecture of the respective architectures that (i) satisfies the maximum latency, (ii) satisfies the maximum amount of memory consumed, and (iii) has a greatest number of decoder parameters for the architectures that satisfy both the maximum latency and maximum amount of memory consumed resulting in the identified TBALM architecture.

In Example 3, at least one of Examples 1-2 can further include using a total number of decoder parameters of the architecture as a proxy for architecture accuracy.

In Example 4, Example 3 can further include, wherein the total number of decoder parameters includes weights and biases of only the decoder of the TBALM architecture.

In Example 5, Example 4 can further include, wherein the decoder parameters include, of the identified TBALM architecture weights of attention heads, model dimensions, inner dimension of a feed forward network (FFN), and number of decoder layers.

In Example 6, at least one of Examples 3-5 can further include, wherein the compute device is a client device, and the method further comprises generating, by the compute device, a pareto curve of number of decoder parameters versus latency for a variety of TBALM architectures, based on a processor of the compute device resulting in a generated pareto curve.

In Example 7, Example 6 can further include, wherein identifying the TBALM architecture of the respective architectures that (i) satisfies the maximum latency and (ii) has a greatest number of decoder parameters for the architectures that satisfy the maximum latency includes selecting the TBALM corresponding to a point at a boundary of the generated pareto curve.

Example 8 includes a device including processing circuitry and a memory including instructions that, when executed by the processing circuitry, cause the processing circuitry to perform the method of one of Examples 1-7.

Example 9 includes a machine readable medium including instructions that, when executed by a machine, cause the machine to perform the method of one of Examples 1-7.

Although a few embodiments have been described in detail above, other modifications are possible. For example, the logic flows depicted in the figures do not require the order shown, or sequential order, to achieve desirable results. Other steps may be provided, or steps may be eliminated, from the described flows, and other components may be added to, or removed from, the described systems. Other embodiments may be within the scope of the following claims.

What is claimed is:

1. A method comprising:
receiving, at a compute device, a request for a transformer-based autoregressive language model (TBALM), the request specifying a maximum latency;
identifying TBALM architectures that satisfy the maximum latency;
identifying a TBALM architecture of the identified TBALM architectures that has a greatest number of decoder parameters resulting in an identified TBALM architecture; and
providing the identified TBALM architecture.

2. The method of claim 1, wherein:
the request further specifies a maximum amount of memory consumed by the TBALM; and
identifying the TBALM architecture includes identifying the TBALM architecture of the respective architectures that (i) satisfies the maximum latency, (ii) satisfies the maximum amount of memory consumed, and (iii) has a greatest number of decoder parameters for the architectures that satisfy both the maximum latency and maximum amount of memory consumed resulting in the identified TBALM architecture.

3. The method of claim 1, further comprising using a total number of decoder parameters of the architecture as a proxy for architecture accuracy.

4. The method of claim 3, wherein the total number of decoder parameters includes weights and biases of only the decoder of the TBALM architecture.

5. The method of claim 4, wherein the decoder parameters include, of the identified TBALM architecture:
weights of attention heads;
model dimensions;
inner dimension of a feed forward network (FFN); and
number of decoder layers.

6. The method of claim 3, wherein:
the compute device is a client device; and
the method further comprises generating, by the compute device, a pareto curve of number of decoder parameters versus latency for a variety of TBALM architectures, based on a processor of the compute device resulting in a generated pareto curve.

7. The method of claim 6, wherein identifying the TBALM architecture of the respective architectures that (i) satisfies the maximum latency and (ii) has a greatest number of decoder parameters for the architectures that satisfy the maximum latency includes selecting the TBALM corresponding to a point at a boundary of the generated pareto curve.

8. A device comprising:
processing circuitry;
a memory including instructions that, when executed by the processing circuitry, cause the processing circuitry to perform operations comprising:
receiving a request for a transformer-based autoregressive language model (TBALM), the request specifying a maximum latency;
identifying TBALM architectures that satisfy the maximum latency;
identifying a TBALM architecture of the identified TBALM architectures that has a greatest number of decoder parameters resulting in an identified TBALM architecture; and
providing the identified TBALM architecture.

9. The system of claim 8, wherein:
the request further specifies a maximum amount of memory consumed by the TBALM; and
identifying the TBALM architecture includes identifying the TBALM architecture of the respective architectures that (i) satisfies the maximum latency, (ii) satisfies the maximum amount of memory consumed, and (iii) has a greatest number of decoder parameters for the architectures that satisfy both the maximum latency and maximum amount of memory consumed resulting in the identified TBALM architecture.

10. The system of claim 8, wherein the operations further comprise using a total number of decoder parameters of the architecture as a proxy for architecture accuracy.

11. The system of claim 10, wherein the total number of decoder parameters includes weights and biases of only the decoder of the TBALM architecture.

12. The system of claim 11, wherein the decoder parameters include, of the identified TBALM architecture:
weights of attention heads;
model dimensions;
inner dimension of a feed forward network (FFN); and
number of decoder layers.

13. The system of claim 10, wherein:
the processing circuitry is part of a client device; and
the operations further comprise generating, by the compute device, a pareto curve of number of decoder parameters versus latency for a variety of TBALM architectures, based on a processor of the compute device resulting in a generated pareto curve.

14. The system of claim 13, wherein identifying the TBALM architecture of the respective architectures that (i) satisfies the maximum latency and (ii) has a greatest number of decoder parameters for the architectures that satisfy the maximum latency includes selecting the TBALM corresponding to a point at a boundary of the generated pareto curve.

15. A machine-readable medium including instructions that, when executed by a machine, cause the machine to perform operations comprising:
receiving a request for a transformer-based autoregressive language model (TBALM), the request specifying a maximum latency;
identifying TBALM architectures that satisfy the maximum latency;
identifying a TBALM architecture of the identified TBALM architectures that has a greatest number of decoder parameters resulting in an identified TBALM architecture; and
providing the identified TBALM architecture.

16. The machine-readable medium of claim 15, wherein:
the request further specifies a maximum amount of memory consumed by the TBALM; and
identifying the TBALM architecture includes identifying the TBALM architecture of the respective architectures that (i) satisfies the maximum latency, (ii) satisfies the maximum amount of memory consumed, and (iii) has a greatest number of decoder parameters for the architectures that satisfy both the maximum latency and maximum amount of memory consumed resulting in the identified TBALM architecture.

17. The machine-readable medium of claim 15, wherein the operations further comprise using a total number of decoder parameters of the architecture as a proxy for architecture accuracy.

18. The machine-readable medium of claim 17, wherein the total number of decoder parameters includes weights and biases of only the decoder of the TBALM architecture.

19. The machine-readable medium of claim 18, wherein the decoder parameters include, of the identified TBALM architecture:
weights of attention heads;
model dimensions;
inner dimension of a feed forward network (FFN); and
number of decoder layers.

20. The machine-readable medium of claim 17, wherein:
the machine is a client device; and
the operations further comprise generating, by the compute device, a pareto curve of number of decoder parameters versus latency for a variety of TBALM architectures, based on a processor of the compute device resulting in a generated pareto curve.
